(19) United States
(12) Patent Application Publication
(10) Pub. No.: US 2010/0213929 A1
(43) Pub. Date: Aug. 26, 2010

(54) ROTOR BLADE SENSOR

(75) Inventors: John Francis Gregg, Oxford (GB); Alexy Davison Karenowska, Oxford (GB)

Correspondence Address: BRINKS HOFER GILSON & LIONE, P.O. BOX 10395, CHICAGO, IL, 60610, US

(73) Assignee: Oxford RF Sensors Ltd., Oxford (GB)

(21) Appl. No.: 12/678,036

(22) PCT Filed: Sep. 8, 2008
(86) PCT No.: PCT/GB08/03041

§ 371 Date: May 10, 2010

(30) Foreign Application Priority Data
Sep. 14, 2007 (GB) 0718005.2

(51) Int. Cl. G01P 3/481; G01B 7/30

(52) U.S. Cl. 324/207.15; 324/166

(57) ABSTRACT

A rotor blade sensor for detecting a rotor blade (430) comprising an electrical oscillator arranged to generate an oscillating signal. An antenna (300) includes a coil (100) having one or two winding layers coupled to the electrical oscillator. The antenna (300) may instead or as well include a coil (100) comprising a plurality of winding layers, each layer being separated by al spacer for substantially reducing inter-layer capacitance, being coupled to the electrical oscillator. The antenna (300) is driven in use by the oscillating signal of the oscillator at substantially a resonant frequency of the antenna (300). The antenna generates an antenna electromagnetic field that interacts with a rotor blade (430) such that the electrical characteristics of the antenna (300) vary as the interaction between the antenna (300) and the rotor blade changes and a detector circuit is arranged to monitor these electrical characteristics.

### FIELD OF THE INVENTION

The present invention relates to a rotor blade detector and in particular a rotor blade detector for sensing the passing of rotor blades and inferring such information as the velocity, position, vibration and or eccentricity thereof.

### BACKGROUND OF THE INVENTION

Turbochargers, rotodynamic machines and other devices containing rotor blades are in widespread use in the transport, industrial and power generation sectors. In the context of such machines, it is often useful or necessary to make real-time measurements of, for example, rotational speed, eccentricity, and bearing run out as the blades pass a particular point, or to detect or measure blade vibration. Moreover, it is useful to detect other material properties relating to the condition of the rotor blades. There is a requirement for sensors to detect and measure the rotational speed of compressor and or turbine blades in gas turbine engines. Furthermore, it is desirable to measure the gaps between the tips of such blades and the surrounding casing as well as neighbouring tips.

Gas turbine engines present significant sensing and instrumentation challenges. This is particularly the case in the turbine section due to high temperatures, the material constraints imposed by the jet engine environment, the high rotational speeds of the turbine blades, and the necessarily high levels of reliability and sensitivity. A more reliable sensor system offering a real-time measurement of the gap between the turbine blade tips and the engine casing or the timing of turbine blades in in-service engines is required.

For laboratory use in the development of both gas turbines and turbochargers, capacitance sensing and optical sensing may be used but these techniques have at least several drawbacks. Among these are; implementation difficulties associated with high temperature, poor measurement resolution, poor measurement accuracy, aging, and lack of robustness to contamination.

There is a drive to improve the efficiency of jet and internal combustion engines motivated by the need to reduce fossil fuel consumption by the transport and power generation sectors, and to reduce harmful gaseous and particulate emissions. The requirement for higher efficiency internal combustion engines leads to a requirement for higher rotational speeds for turbochargers, higher operating temperatures, smaller dimensions and alternative materials, including titanium, for instance, for the compressor impeller blades of such turbochargers. Moreover, higher turbine entry temperatures are desirable in the development of more efficient jet engines, necessitating the use of materials such as titanium and nickel, and alloys thereof in the manufacture of turbine and compressor blades. All of the above factors introduce a demand for ever higher performance sensing solutions.

Gas turbine efficiency is substantially influenced by the gap between turbine rotor blade tips and the turbine casing. It is desirable to minimize the tip-casing spacing whilst avoiding mechanical interference. In the absence of a sensor to measure this gap, it is not feasible to fit a closed loop control system to optimise this gap.

In rotor blade sensing applications the four main technologies currently in use are; variable reluctance sensors, eddy current sensors, capacitive sensors and optical sensors. All of these technologies have at least several shortcomings.

Variable reluctance sensors require a ferrous target. Turbocharger rotor blades are in general non-ferrous. As a result, in such applications as measuring the rotational speed of a turbocharger, variable reluctance sensing is generally restricted to applications where it is possible to mount a ferrous target on the centre shaft of the device. Such sensors usually need to operate at high temperature. Moreover, the magnitude of the sensor output signal is typically proportional to the rotational speed of the shaft and thus low at low rotational speeds.

Eddy current sensor technologies perform well in conjunction with turbocharger impellers that have good electrical conductivity. However, they give poor sensitivity with titanium and other non-ferrous or alloyed metal impellers of low electrical conductivity. Similarly, problems are encountered when attempting to detect blades manufactured from titanium and nickel superalloys such as for instance, in gas turbine engines.

“Detecting and Building an Eddy Current Position Sensor”, Steven D. Roach, Hewlett-Packard, Electronic Measurements Division (http://archives.sensorsmag.com/articles/0998/ed0998/index.htm) describes the design considerations for eddy current sensors including the requirements regarding drive frequency and quality factor (Q). These eddy current sensors monitor changes in the inductance of a coil brought about by the presence of a metallic target. The inductance is monitored by measuring the frequency of oscillation in these eddy current sensors. For the eddy current sensors to operate in this inductance sensing mode, the oscillator must operate well below the resonant frequency of the coil. In order to maintain the required high Q and inductance of the coil (and so maintain signal) in this frequency range, thin wire is used to increase the coil turn density and the total number of turns. Furthermore, multiple winding layers are recommended to further increase the Q.

Capacitance sensors suffer from poor signal-to-noise owing to typically very small measurement capacitances and correspondingly small absolute values of capacitance change from which the position signal is derived. Furthermore, such sensors may easily be fouled by soot and other contaminants.

Optical sensors may work well initially, but may be unreliable in the long term or have limited operational lifetime owing to the potential for fouling by soot and other contaminants.

Therefore, there is required an improved rotor blade detector.

### SUMMARY OF THE INVENTION

In accordance with a first aspect of the present invention there is provided a rotor blade sensor that detects a passing or static rotor blade by using a sensor electromagnetic field, originating from an antenna driven by an electrical oscillator. The antenna comprises a coil having one or two winding layers. The electrical oscillator excites the antenna at substantially a resonant frequency of the antenna. The electrical characteristics (for example operating frequency and/or Q) of the antenna and/or driving oscillator are monitored. Change or changes in these electrical characteristics are used to detect the rotor blade or to measure its properties. The electrical characteristics of the antenna may be monitored indirectly by monitoring the electrical characteristics of the electrical oscillator. In accordance with this first aspect of the present invention, an antenna coil with one or two winding layers is used. With such an antenna, in-phase addition of magnetic field components arising from currents in distinct turns of the coil may be achieved when the antenna is excited at resonance. In order to operate with high sensitivity in conjunction with thin rotor blade targets of low electrical conductivity, instead of operating in an inductance sensing mode as in the prior art eddy current sensors, the rotor blade sensor instead operates preferably in a loss sensing mode.

Preferably, the resonant frequency at which the sensor antenna operates is the lowest resonant frequency of the antenna (which may exhibit several resonant frequencies, of course). In this ‘strong’ resonant frequency regime, good sensitivity is achieved.

Where the coil of the antenna is a single layer, there is no well defined coil capacitance so the lowest resonant frequency (which is sometimes referred to as self resonance) is very high and results from stray effects. In that case, the antenna may also include a capacitor in parallel with the coil to define a resonant circuit having a resonant peak at a frequency suitable for convenient operation at, say, 10-100 MHz. Additionally or alternatively, lossy connecting wires to the coil may be used to pull down the resonant frequency of the resultant antenna to a suitable frequency.

Where the coil is dual layer, the self inductance of the coil along with the inter-layer capacitance provides a well defined resonant frequency at a suitable frequency for convenient operation. With a dual layer coil, the inter-layer capacitance does not rob the junction of the two layers of current so that the currents in the windings of the two layers remain in phase. Nevertheless, if further alteration of the resonant frequency of the antenna is desired, then a further capacitance (such as a dedicated capacitor or long cables, for example) can be employed in parallel.

Advantageously, the rotor blade sensor invention is suited to the determination of the distance between the tip of a rotor blade in a rotodynamic machine and another static or dynamic object. Advantages include compactness, simplicity of design, resolution, ruggedness and signal to noise.

Advantageously, the present invention has enhanced capability to detect rotor blades with thin, high-resistivity surfaces or surface coatings or non-ferrous or alloyed rotor blades. Rotor blade materials compatible with the present invention include titanium, nickel, aluminium, vanadium, copper, iron, manganese, molybdenum and magnesium, for instance.

Advantageously, the antenna coil may be coreless. The present invention circumvents the requirement for a magnetic antenna coil core. Furthermore, there is no requirement in the present invention for the inclusion of a permanent magnet in the sensing system.

It is arranged that an alternating electromagnetic field is produced by the sensor antenna in the region of the rotor blade. The rotor blade perturbs the electromagnetic field originating from the sensor antenna and this perturbation is detected by monitoring the electrical characteristics of the antenna and/or the electrical oscillator used to excite the antenna.

Preferably, the antenna may be arranged to interact with a rotor blade by moving the rotor blade past or relative to the antenna.

Preferably, the electrical characteristics of the antenna arranged to be monitored by the detector circuit include a resonant frequency of the antenna.

More preferably for the case of thin targets of low electrical conductivity, the Q of the antenna or the circuit driving the antenna may be monitored by the detector circuit. The Q may be monitored by monitoring the amplitude of the oscillating signal driving the antenna. The presence of, motion of, position of, or changes in properties of the rotor blade may bring about changes in the antenna-driving-circuit system loss, altering the measured Q. These changes in loss and/or Q may be inferred from the amplitude of the antenna excitation.

Advantageously, the antenna further comprises a shunt conductance arranged to control the Q of the antenna. The shunt conductance may comprise a coaxial cable arranged to couple the electrical oscillator to the coil. Such a coaxial cable introduces further dielectric losses and may be used for the purposes of tuning the resonant frequency and/or altering the Q of the antenna. Other connections such and twisted pair cables and transmission lines may be used.

Optionally, the antenna may further comprise a capacitor arranged in parallel with the coil. This allows the resonant frequency of the antenna to be controlled or lowered.

Preferably, when the capacitor and coaxial cable are part of the antenna, the capacitor may be arranged across the coaxial cable proximal to the end of the coaxial cable towards the coil. In other words, the capacitor may be placed across the coil reducing the influence on antenna characteristics of the connecting cable. Connectors other than coaxial cable may be used.

Preferably, the number of turns in the coil or each layer of the coil is less than or equal to 20. This simplifies construction.
Advantageously, the detector circuit may be a Robinson demodulator detector.
Optionally, the detector circuit may be further arranged to indicate velocity, angular velocity, blade separation, antenna-blade separation, vibration, eccentricity or material properties of the rotor blade by monitoring the electrical characteristics of the antenna.
Optionally, the coil may be formed from wire having a diameter greater than 0.25 mm. This improves the robustness of the antenna and reduces the electrical loss in the antenna.

Optionally, the electrical oscillator and detector circuit are integral.

Preferably, the electrical oscillator may be arranged to oscillate at a frequency above 1 MHz or more preferably above 3 MHz or more preferably still above 10 MHz. These frequencies are significantly above the blade pass frequency of a typical rotodynamic machine.

Preferably, the electrical oscillator may be arranged to oscillate at any frequency between 1 and 100 MHz.

Optionally, the electrical oscillator may be arranged to oscillate at a frequency above 100 MHz.

Advantageously, it is arranged that induced surface currents in the rotor blade, originating from the alternating electromagnetic field produced by the sensor antenna are such that the passing rotor blade behaves as a diamagnet i.e. such that the skin depth of the sensor electromagnetic field is less than or substantially less than the thickness of the rotor blade. This arrangement leads to a higher sensitivity sensor system.
It is noted that the blades of such rotodynamic machines as are described in the context of the present invention typically have complex geometry. Specifically, the thickness of such blades generally varies with distance along the chord of the blade and along its length. Furthermore the blade may exhibit twist. Consequently, the frequency of antenna excitation required such that the skin depth of the sensor electromagnetic field is less than or equal to the thickness of the rotor blade is likely to depend upon where the antenna is disposed relative to the blade. It is envisaged that the frequency of antenna excitation will be chosen so that for the majority of the part of the rotor blade that invades the antenna “sensitive volume”, the skin depth is either; of the same order as the thickness of the blade, less than the thickness of the blade or substantially less than the thickness of the blade.

Optionally, the antenna may further comprise a metal shroud or a shroud of some other material for example plastic, with surfaces plated or coated with a metal or other conducting material where the thickness of this plating or coating is greater than or equal to the skin depth therein at the operating frequency of the sensor. Such a shroud may behave substantially as a diamagnet and may be used to focus or direct a magnetic field generated by the antenna and or/to exclude the magnetic field from certain areas. For brevity, any such a shroud will be referred to subsequently as a ‘shroud’ or ‘metallic shroud’. The shroud may be cylindrical and may be closed at one end and have a restricted opening, for instance.

Optionally, the antenna may further comprise thin pieces or sheets of metal or some other material for example plastic, with surfaces plated or coated with a metal or other conducting material where the thickness of this plating or coating is greater than or equal to the skin depth therein at the operating frequency of the sensor. Such pieces or sheets may behave substantially as diamagents and may be used to shape the sensor electromagnetic field. For brevity, any such shaping pieces will be referred to subsequently as a ‘pieces’ or ‘sheets’ or ‘metal pieces/sheets’ or ‘thin metal pieces/sheets’.

Preferably, the metal or metallic plating of the shroud and/or metal sheets may be copper or another metal of high electrical conductivity.

In accordance with a second aspect of the present invention there is provided a rotor blade sensor for detecting a rotor blade comprising an electrical oscillator arranged to generate an oscillating signal; an antenna comprising a coil having a plurality of winding layers with successive layers being separated by a spacer for substantially reducing inter-layer capacitance and coupled to the electrical oscillator, and having a plurality of electrical characteristics, and arranged to be driven by the oscillating signal at substantially a resonant frequency of the antenna, and to generate an antenna electromagnetic field that interacts with a rotor blade such that the electrical characteristics of the antenna vary as the interaction between the antenna and the rotor blade changes; and a detector circuit arranged to monitor the electrical characteristics of the antenna. The additional features mentioned above may also be incorporated into the second aspect of the present invention. Furthermore, in this second aspect of the present invention the plurality of winding layers may be more than two.

Preferably, the spacer or spacers are thick enough such that inter-layer capacitances are reduced to such an extent that in use, the currents flowing in each turn of the coil are substantially in phase.

The rotor blade detector may be used in conjunction with a turbo or turbine. This turbo or turbine may be installed on a vehicle for example, a car, boat, train, aircraft etc., or may be installed in static plant e.g. power generation. Other devices containing moving or passing blades may also be monitored in this way for example hydrodynamic machines, pumps and devices with a linear movement.

### BRIEF DESCRIPTION OF THE FIGURES

The present invention may be put into practice in a number of ways and embodiments will now be described by way of example only and with reference to the accompanying drawings, in which:

FIG. 1A shows a schematic diagram of a magnetic field pattern arising due to an applied current in a single layer coil;

FIG. 1B shows a schematic diagram of a magnetic field pattern arising due to a current applied to the single layer coil of FIG. 1A in the presence of a metallic target;

FIG. 1C shows a schematic diagram of a magnetic field pattern arising due to a current applied to the single layer coil of FIG. 1B with a reduced separation of the metallic target and the single layer coil;

FIG. 2A shows a schematic diagram of a two layer coil;

FIG. 2B shows a schematic diagram of the single layer coil of FIG. 1A;

FIG. 3A shows a cross sectional view of an antenna according to one embodiment of the present invention, including the coil of FIGS. 1A-C and a diamagnetic shroud;

FIG. 3B shows a cross sectional view of the antenna of FIG. 3A including a sensitive volume of the sensor;

FIG. 4 shows a schematic diagram of a system for sensing rotor blades according to one embodiment of the present invention, given by way of example only;

FIG. 5 shows in schematic form a top view, a side view and a cross-sectional view of a rotor blade interacting with the sensitive volume of the sensor indicated in FIG. 3B;

FIG. 6 shows an equivalent circuit of the single layer coil of FIG. 1A having an inductance and inter-turn capacitances;

FIG. 7 shows an equivalent circuit representing the single layer coil of FIG. 1A and an external capacitor;

FIG. 8 shows an equivalent circuit of the arrangement shown in FIG. 7;

FIG. 9 shows an equivalent circuit of the two layer coil of FIG. 2B and an external capacitor;

FIG. 10 shows a simplified equivalent circuit of the arrangement shown in FIG. 9;

FIG. 11 shows a still more simplified equivalent circuit of the arrangement shown in FIG. 9;

FIG. 12 shows an equivalent circuit of coils with more than one winding layer (in this case, four winding layers) including capacitances between winding layers;

FIG. 13 shows a simplified equivalent circuit of the arrangement shown in FIG. 12;

FIG. 14 shows the equivalent circuit of FIG. 13 and an external capacitor;

FIG. 15A shows a phasor diagram representing the vector magnetic field for each layer in a five winding layer coil operated at low frequency;

FIG. 15B shows a phasor diagram representing the vector magnetic field for each layer in a five winding layer coil operated such that a phase discrepancy exists between the magnetic field provided by each winding layer;

FIG. 15C shows a phasor diagram representing the vector magnetic field for each layer in a five winding layer coil operated such that a large phase discrepancy exists between the magnetic field provided by each winding layer; and

FIG. 15D shows a phasor diagram representing the vector magnetic field for each layer in a five winding layer coil where the phase differences between the magnetic field contributions from each winding layer are such that the net magnetic field is zero;

FIG. 16 shows a graph of power absorption for different rotor blade thicknesses at different sensor operating frequencies.

It should be noted that the figures are illustrated for simplicity and are not necessarily drawn to scale.

### DETAILED DESCRIPTION OF THE PREFERRED EMBODIMENTS

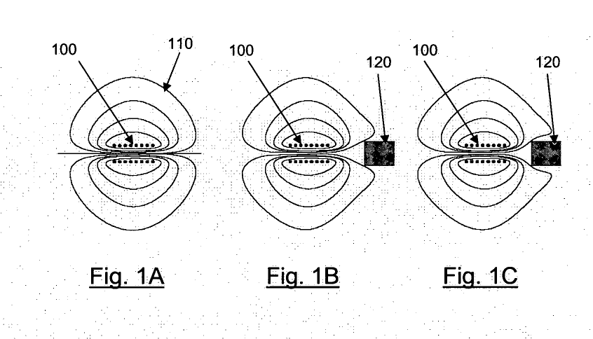

Before describing preferred embodiments of the present invention it is useful to describe the effect of a metal target on a magnetic field produced by an energised antenna. FIGS. 1A-C show in schematic form the lines of magnetic flux 110 produced by a single layer coil 100.

Like features in the figures have been given the same reference numerals.

FIG. 1A shows a schematic diagram of a magnetic field pattern arising due to an alternating applied current in a single winding layer coil 100 at an instant in time. The polarity of the magnetic field arising from such AC excitation of the coil reverses once every half cycle. In the absence of any metallic shrouding or target, the magnetic field 110 originated by the coil 100 extends to infinity in all directions.

FIG. 1B shows a schematic diagram of the magnetic field pattern 110 arising from the coil arrangement of FIG. 1A in the presence of a metallic target 120. The frequency of the AC excitation of the coil is such that magnetic flux is excluded from the bulk of the target and consequently ‘crowded’ in the region adjacent to it.

FIG. 1C shows schematically the effect of reduced coil-target distance on the magnetic field pattern 110 of FIG. 1B.

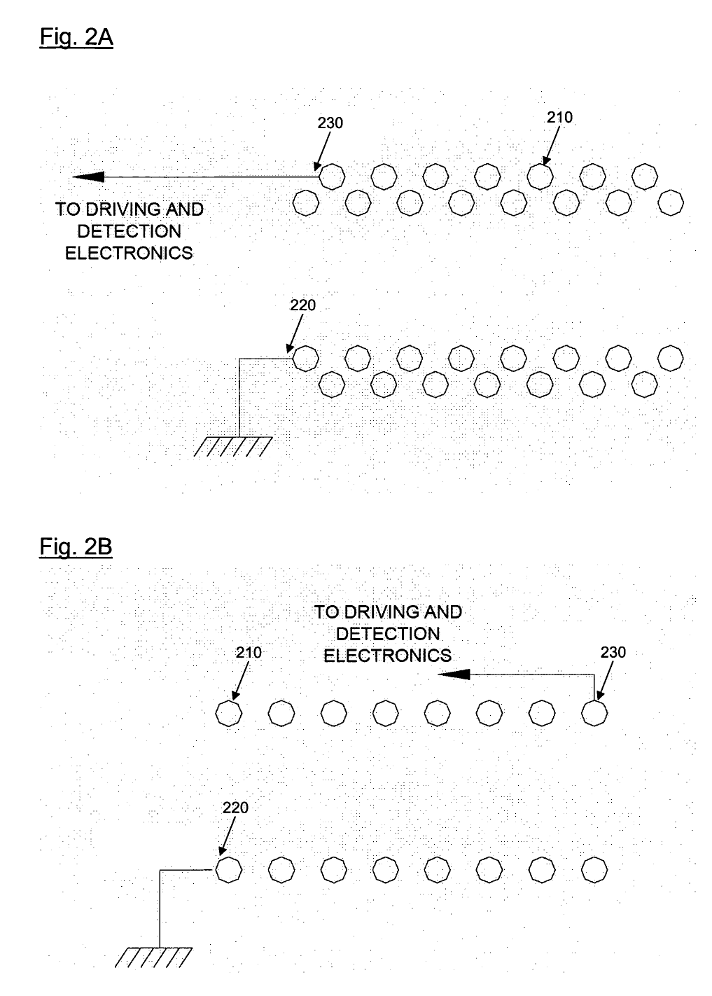

FIGS. 2A-B show schematic diagrams of two different coil arrangements forming antennae (or parts thereof) according to two preferred embodiments of the present invention.

Both the one and two-layer coil arrangements allow the antenna to exhibit a ‘strong’ resonant frequency. In use, when an alternating current at the ‘strong’ resonant frequency is flowing through each coil type, currents in all turns of the coil are substantially in phase and therefore each gives rise to magnetic field components which add in phase to achieve an increased sensor magnetic field.

FIG. 2A shows a schematic cross-sectional diagram through a two-layer coil formed from an insulated wire 210. The wires may have any suitable cross-sectional shape such as circular, for instance. An end 220 of the wire 210 is grounded and the other end 230 is coupled to driving and detection electronics.

FIG. 2B shows a similar cross-sectional schematic diagram through a single layer coil also formed from an insulated wire 210. Again, one end 220 of the wire 210 is grounded and the other end 230 is coupled to the driving and detection electronics. In the two-layer coil there will be an inter-layer capacitance. However, this inter-layer capacitance does not cause dephasing of the magnetic field contributions to the total sensor magnetic field arising from different turns of the winding. Since the inter-layer capacitance does not rob current from the junction of the two layers, so the currents in the two layers remain in phase.

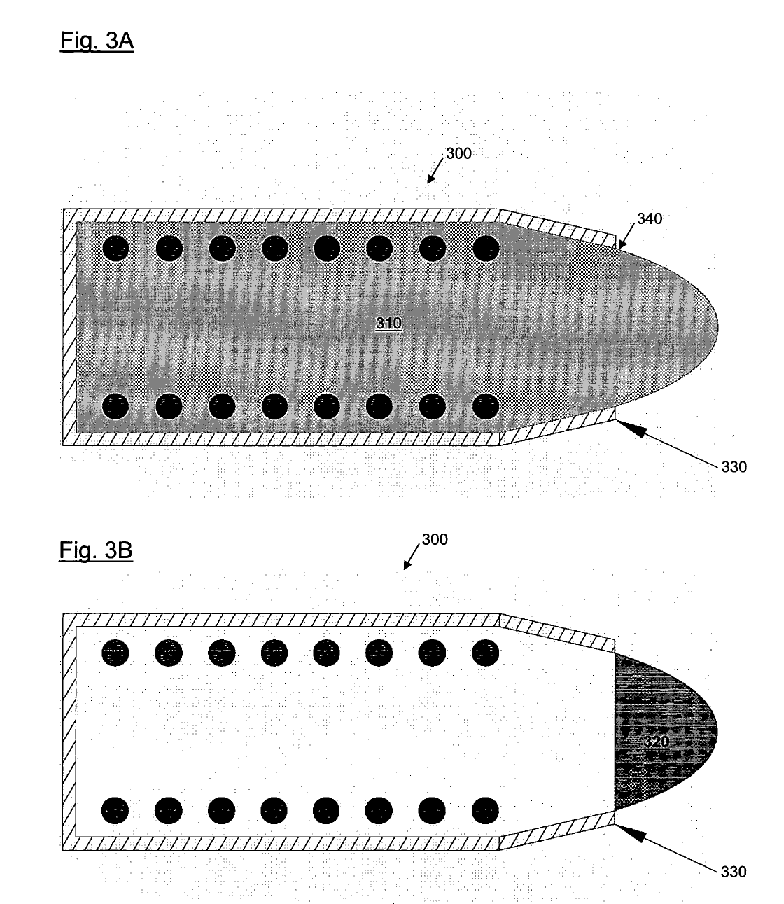

In accordance with the first aspect of the present invention, the antenna comprises or includes a helical coil (with either single or double winding layers). FIGS. 3A-B show schematic cross-sectional diagrams through a single layer coil antenna 300. A metallic or metal coated cylindrical shroud 330 encapsulates the single layer coil 100 forming a substantially diamagnetic enclosure along the axis of the coil 100. At one end of the shroud 330 there is an opening 340. The opening 340 is constrained by shaping of the shroud at this end. The other end of the cylindrical shroud 330 is closed but may incorporate an opening for electrical connections to be made to the assembly (not shown in this figure).

The metallic shroud 330 substantially confines the magnetic field produced by the coil 100 to a region defined by area 310. Due to the opening 340 in the metallic shroud a small sensitive volume 320 is provided, which extends beyond the end with the opening 340. In this way the metallic or metal coated shroud defines and shapes the sensitive volume 320 which is determined by the geometry of the coil 100 and the metallic shroud 300. The shroud may take other shapes, designs and sizes depending on the required sensitive volume. Other components of the antenna such as for instance, electrical connectors and cables are not shown in these figures.

The antenna is operated under resonant conditions.

To further enhance the performance of the sensor, the rotor blade 430 should have the largest possible “filling factor” with respect to the antenna; in other words, it should intercept as much as possible of the energy stored in the magnetic field surrounding the antenna 300 and hence cause a larger perturbation to the magnetic flux-lines generated by the antenna 300. To increase the filling factor, the magnetic field originating from the antenna may be shaped, as discussed with reference to FIGS. 3A-B. Preferably, the antenna 300 may be operated at MHz frequencies. In an alternative embodiment, in addition to or in place of the metallic shroud 300, thin metal pieces may be placed near the antenna 300 to shape the magnetic field.

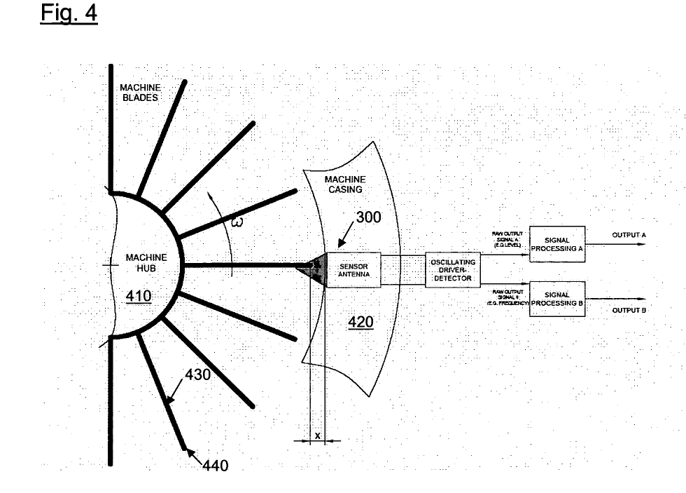

FIG. 4 shows a schematic diagram of a rotor blade sensor installed within an example rotodynamic machine. Not all components of the rotodynamic machine are shown for the sake of clarity. The rotodynamic machine comprises a machine hub 410 and several rotor blades 430 each having a rotor blade tip 440. The rotor blades 430 rotate at an angular velocity w. A machine casing 420 encloses the rotor blades 430 and machine hub 410. In FIG. 4 only a portion of the machine casing 420 is shown. The casing-rotor blade tip separation is shown in FIG. 4 as x. The antenna 300 is set within a bore through the machine casing 420 and arranged so that the rotor blade tips 440 may intersect the sensitive volume 320 as the rotor blades 430 rotate. The extent of the magnetic field originating from the antenna is limited to the sensitive volume 320 of the device. This “sensitive volume” is defined by the geometry of the antenna and achieved via the use of a metallic shroud or thin metal pieces, as discussed above. The antenna 300 is coupled to an oscillating driver and detector circuit, which may have several outputs. For instance, output A provides the amplitude of oscillation of the oscillator driving circuit and output B provides the oscillation frequency. These outputs vary as the rotor blade tips 440 invade or pass through the sensitive area 320.

In this embodiment, the oscillating driver and detector circuits are shown as a single ‘driver-detector’ circuit but in other alternative embodiments separate oscillator and detector circuits may be used. The antenna 300 and oscillating driver-detector form a resonant circuit with the oscillator exciting the antenna 300 at a resonant frequency. With a single or double layer coil 100, the antenna 300 may be designed such that it exhibits single ‘strong’ resonant frequency.

When a rotor blade 430 enters the sensitive volume 320 of the antenna 300 the electromagnetic field in this region is perturbed. This perturbation brings about a change in the electrical impedance of the antenna 300. This change in electrical impedance in turn originates a change or changes in the operating frequency, amplitude and/or other electrical properties of the antenna-driver system. These changes are detected via the driver-detector. Thus, the frequency and/or amplitude change, or changes in other electrical properties of the oscillator may be used to indicate the presence of the rotor blade, the separation of the antenna and rotor blade, or other properties of the passing rotor blade, these may include for example; velocity, vibration, eccentricity, material properties.

The information from output A and/or output B may be processed further by other circuitry or processors (not shown in this figure) to obtain information such as for instance, the separation between each rotor blade 430, the average value of this separation, the rotor blade tip 440-machine casing 420 separation and/or the rotor blades' 430 angular velocity w.

In a further embodiment of the present invention the functions of driving and detection may be combined into a single driver-detector circuit using a Robinson type positive feedback oscillator. The closed-loop Robinson oscillator system is arranged so as to sustain oscillations of the resonant circuit. This oscillation gives rise to an alternating electromagnetic field in the region of the antenna.

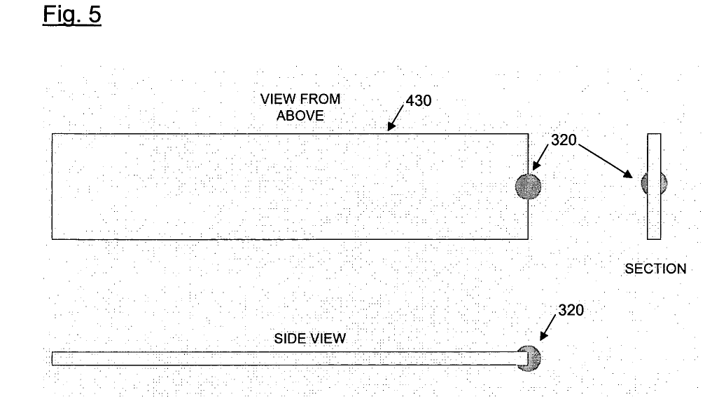

FIG. 5 shows in schematic form a top view, a side view and a cross-sectional view of one of the rotor blades 430 of FIG. 4 as the rotor blade 430 interacts with the sensitive volume 320. The rotor blade 430 is interrogated end on, i.e. with the coil's axis pointing in the direction of the long axis of the rotor blade 430. The side view and sectional view of FIG. 5 indicate that for thin rotor blades or other thin targets 430, the volume in which the induced magnetisation is present (the sensitive volume 320) is extremely small. However, even with this small volume, sufficient signal may be obtained due to the sensor operating in a loss sensing mode.

Operating in loss sensing mode achieves greater sensitivity than eddy current sensors that operate in frequency-sensing mode by detecting changes in inductance ΔL, where the target has either or both, a) a high surface area to volume ratio (i.e. the target is ‘thin’), b) a low electrical conductivity. ΔL is a measure of the magnetisation induced in the target by the coil. For thin targets viewed ‘end on’ (as shown in FIG. 5) the measured ΔL is small and sensitivity is poor.

In the case of thin targets of low electrical conductivity, the measured effect is furthermore reduced since the induced magnetisation per unit volume is smaller still. Under these circumstances, the rotor may become effectively invisible to a conventional eddy current sensor. Measuring the change in electrical loss of the antenna has several advantages over such sensors.

In the case of thin targets as shown in FIG. 5, the measured quantity ΔL is roughly proportional to the volume of the target, whilst losses scale with the target surface area. Thus, for targets with a large surface area to volume ratio (e.g. thin rotors) a sensor system measuring the loss signal is more sensitive than one which attempts to measure the change in inductance ΔL.

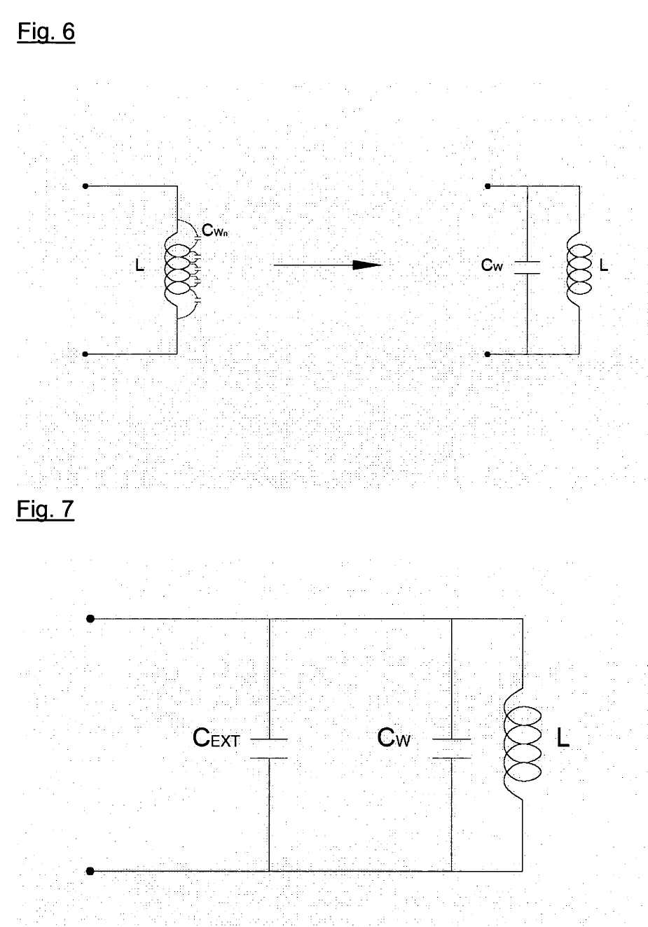

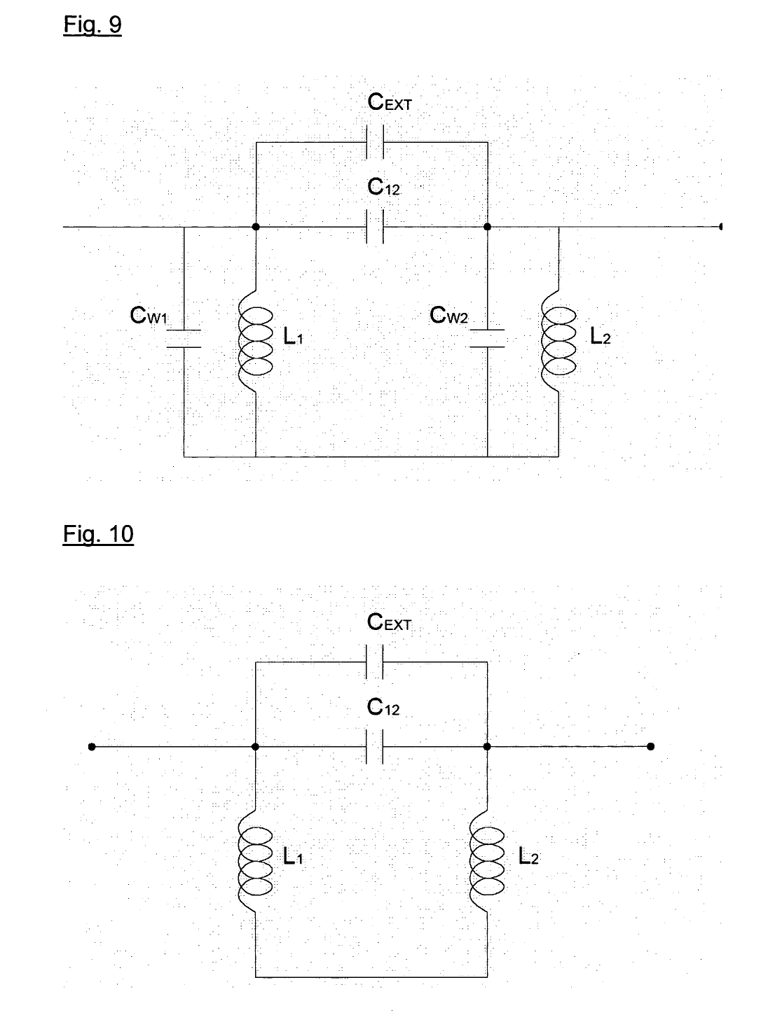

FIGS. 6-11 show equivalent circuits for antennas used in various embodiments of the present invention. FIGS. 6-8 show equivalent circuits for a one-layer coil based antenna and FIGS. 9-11 show equivalent circuits for a two-layer coil based antenna.

On the left hand side of FIG. 6 there is shown an equivalent circuit for a single layer coil 100 having an inductance L. An inter-turn capacitance C_{Wn} is associated with each turn of the coil 100. These individual capacitances may be represented by an equivalent inter-turn capacitance C_{W} in parallel with the coil 100, as shown on the right hand side of FIG. 6.

As shown in FIG. 6, there will be an inter-turn capacitance C_{Wn} associated with each turn of a single layer coil. Moreover, each turn of the sensor coil has associated with it an inductance lₙ. It is evident therefore that each lₙ-C_{Wn} sub-system of the coil has a resonance associated with it. However, these resonances will be insignificant in comparison with the ‘strong’ resonance and so may be neglected. This may be further justified by considering the location of these resonant frequencies, and is best illustrated by the following example. In the case of a 5 mm diameter coil wound with 0.25 mm diameter wire, the sub-system resonant frequency is around 4 GHz, reducing the coil diameter to 2.5 mm increases this frequency to in excess of 6 GHz; this is at least an order of magnitude above the operating frequency the device.

The signal bandwidth, B of the present sensor invention is determined by the quality factor, Q, of the antenna-detector system,

B=ω/Q Equation 1

where ω is the angular operating frequency of the antenna. As is evident from equation 1, the signal bandwidth of the present sensor invention is reduced by a high Q. By deliberately introducing a carefully controlled loss in the form of a shunt conductance G′ into the circuit, the signal bandwidth may be defined and controlled by altering the quality factor. When a target approaches the sensor, two effects contribute to the signal:

1. A loss signal arising directly from electrical dissipation in the rotor; and

2. A change in the apparent shunt conductance (inversely proportional the signal output) of the coil may be caused by a change in the operating frequency.

It is arranged that the shunt conductance of the coil/cable assembly according to an embodiment of the present invention varies in direct proportion with ω. (It is noted that the shunt conductance G, of a conventional eddy current sensor varies as ω^{1/2}). This embodiment of the present invention results in a sensor signal dominated by effect 2, above. In this embodiment of the present invention it is preferable that the deliberately introduced loss G′ dominates the circuit Q and therefore that the coil series resistance is reduced, this may be accomplished by manufacturing the coil from a wire of comparatively large diameter (>0.25 mm) and/or using a coil with few turns.

FIG. 7 shows an equivalent circuit of an antenna used in another embodiment of the present invention. In this embodiment an external capacitor C_{EXT} is connected in parallel with the coil 100. The value of C_{EXT} is chosen to modify the resonant frequency of the coil 100 and capacitor circuit to form an antenna that has a particular desired operating frequency. The external capacitor C_{EXT} may be used to modify the resonant frequency of the antenna 300. In the context of the present invention, the capacitor C_{EXT} is generally used to lower the antenna resonant frequency.

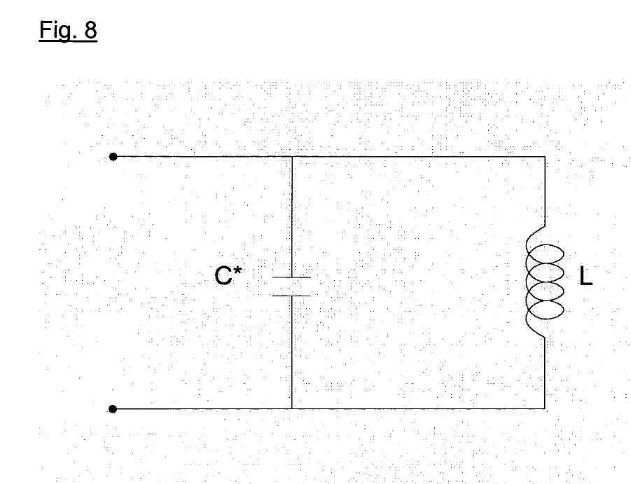

FIG. 8 shows a further simplified version of the equivalent circuit shown in FIG. 7. In this simplified circuit, the external capacitor C_{EXT} and the inter-turn equivalent capacitance C_{W} are combined as a single capacitance C*. The resonant frequency of the overall system is given by:

$${f}_{0} = \frac{1}{2 π \sqrt{{LC}^{*}}} \qquad Equation 2$$

In order to minimise loss in connecting cables and thus maximise the efficiency of the sensor, it may be desirable to minimise the value of the capacitor C_{EXT}. In a preferred embodiment this may be achieved by increasing the value of C₁₂ via the use of an inter-layer dielectric.

As described above, the invention may be put into effect using either a one or a two layer coil 100. FIGS. 9-11 show equivalent circuits representing a two-layer coil based antenna used in alternative embodiments of the present invention.

In FIG. 9, each of the two winding layers is represented by a separate inductance L₁ and L₂. Capacitances C_{W1} and C_{W2} are respectively equivalent to the sum of the inter-turn capacitances of inductors L₁ and L₂ (compare with the one-layer coil of FIG. 6). The capacitance C₁₂ is that which appears between the two winding layers. The external capacitor C_{EXT} is included to modify the resonant frequency of the antenna 300 and appears in parallel with capacitance C₁₂.

In practice, the capacitances C_{W1} and C_{W2} are small in comparison with C₁₂. Therefore, the equivalent circuit may be simplified further by neglecting C_{W1} and C_{W2}, as shown in FIG. 10.

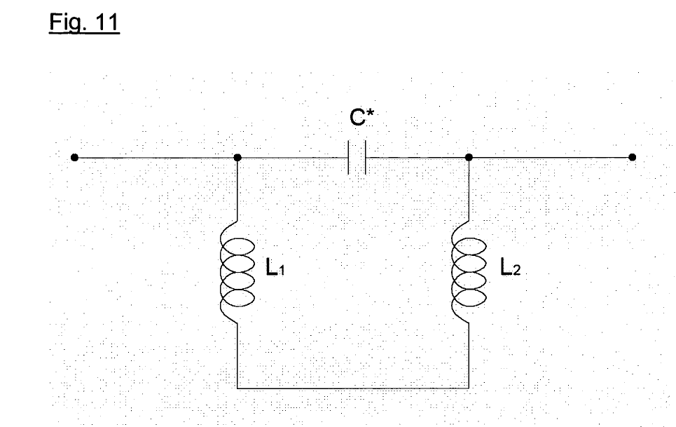

FIG. 11 shows a further simplified equivalent circuit for a two-layer coil based antenna. The parallel capacitors C_{EXT} and C₁₂ have been combined into a single element C.

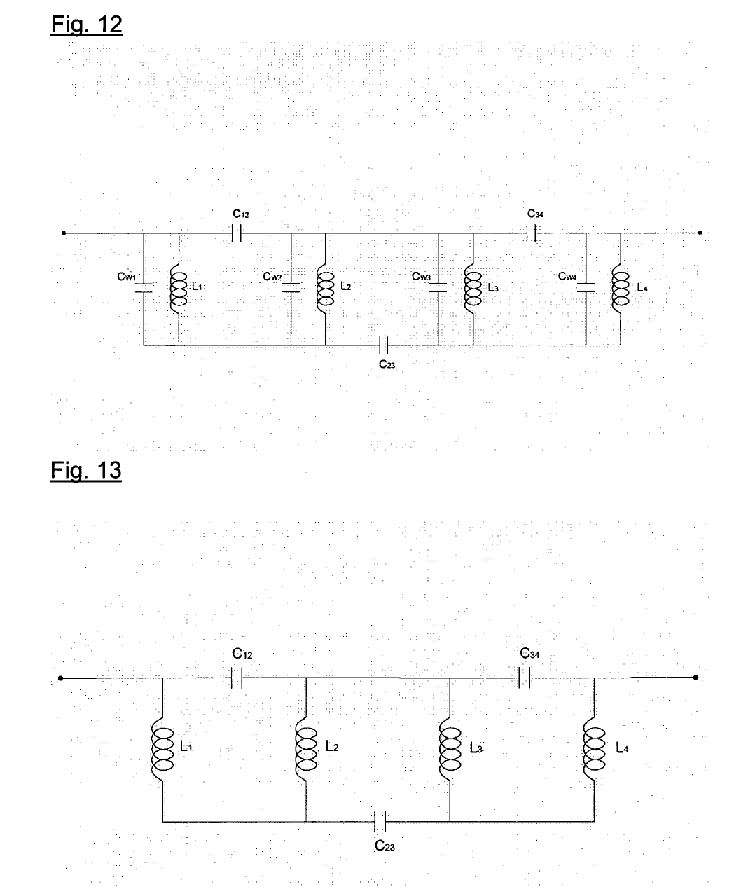

Antennae incorporating such one and two layer coils are characterised by a single ‘strong’ resonant frequency at which magnetic field contributions arising from currents flowing in each turn of each winding layer are substantially in phase. FIGS. 12-14 show equivalent circuits for antennas comprising coils with more than two layers. Such coils are typical in prior art eddy current sensors.

FIG. 12 shows an equivalent circuit for a four winding layer coil. Inductances L₁, L₂, L₃ and L₄ represent the inductances of each individual winding layer. The respective inter-turn equivalent capacitances are given by C_{W1}, C_{W2}, C_{W3} and C_{W4}. Inter-layer capacitances are shown as C₁₂, C₂₃ and C₃₄ and these are between winding layers 1 and 2, 2 and 3 and 3 and 4, respectively. Again, it is reasonable to neglect the inter-turn capacitances as the inter-layer capacitances predominate. FIG. 13 shows a simplified equivalent circuit to that of FIG. 12.

With a coil having more than two winding layers it can be shown that there are twice the number of fundamental resonant frequencies as the number of winding layers, i.e. eight fundamental resonant frequencies will be observed in the four layer coil case. Increasing the number of winding layers therefore increases the complexity of the antenna's resonant response.

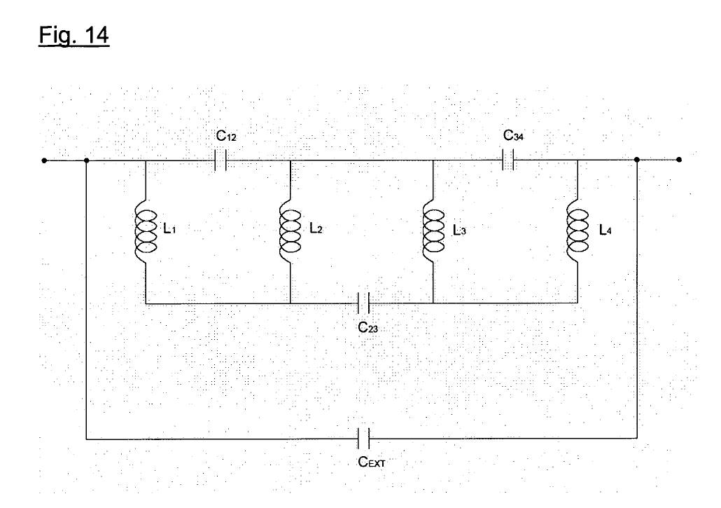

As shown in FIG. 14, the addition of an external capacitor C_{EXT} further complicates the circuit model and thus the complexity of the frequency response. The efficiency of such an antenna is reduced compared to that of one or two layer coil antennae since the single ‘strong’ resonance described above is not observed.

In general, inter-layer capacitances in simple multilayer coils (i.e. >2 winding layers) extract current from the layer junctions resulting in phase discrepancy between currents flowing in successive layers.

In an alternative embodiment of the present invention, a multilayer coil (i.e. >2 winding layers) may be employed. In this specially designed multilayer coil, a spacer or spacer layer separates each layer of coil windings. The thickness and properties of these spacer layers are chosen so as to render inter-layer capacitances negligible so that these capacitances do not take appreciable current from the junctions of the winding layers during operation. Under these conditions, the antenna exhibits a single ‘strong’ resonant frequency at which the currents flowing within each turn of each layer of the coil are substantially in phase with each other and accordingly the magnetic field contributions arising from each turn of the coil add in phase to produce an increased sensor magnetic field.

As stated above, high performance and sensitivity of the present invention is achieved by designing the sensor coil in such a way as to ensure that all magnetic field contributions originating from individual turns of the sensor coil are in phase. In order to arrange this, it is desirable to ensure that the antenna has a single ‘strong’ resonant frequency and this condition is satisfied if and only if the coil has either 1 or 2 layers or the coil has more layers with inter-layer spacers to suppress inter-layer capacitances.

The terms target, rotor blade, rotor and blade are used interchangeably.

Coils with more than two winding layers may only be used in embodiments of the present invention where phase discrepancies in the magnetic fields due to each winding layer are minimal. One way to achieve this is to reduce the capacitance between layers by for example, introducing suitable spacers between winding layers.

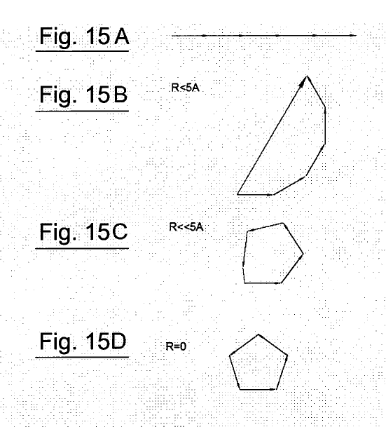

FIGS. 15A-D show phasor diagrams representing magnetic fields generated by each winding layer in a five layer coil with no inter-layer spacers. ‘R’ is the vector of ‘resultant’ magnetic field. For simplicity, the magnitude of the magnetic field that arises due to the excitation of each layer of the coil winding is considered constant and equal to a value A; thus the maximum value of R realisable in the case of a five layer coil is 5A. A value of R close to the maximum is preferable for good sensor performance.

FIG. 15A shows in-phase addition of magnetic field components (i.e. R=5A in this case). In practice this condition is difficult to achieve except at very low frequency (e.g. DC).

FIG. 15B shows how the phasor addition of magnetic field components arising from successive winding layers results in a vector R with a magnitude less than the optimum (i.e. R<5A in this case). (Note that for simplicity phase discrepancies between successive layers are shown to be equal—in reality this is unlikely to be the case but this simplified representation illustrates the net detrimental effect on coil performance). A sensor operating under these conditions will have poor performance.

FIG. 15C illustrates the case of near-complete destructive interference of magnetic field components arising from successive winding layers. The vector R has a magnitude very close to zero. In such a case the sensor will have very poor performance.

FIG. 15D illustrates the case of complete destructive interference of magnetic field components arising from successive winding layers. This may be described as an ‘anti-resonance’ condition. In this case R=0 and the coil cannot function as a sensor antenna at all. In a coil with many winding layers (more than two) this condition (or very near to it i.e. 15C) may well be realised.

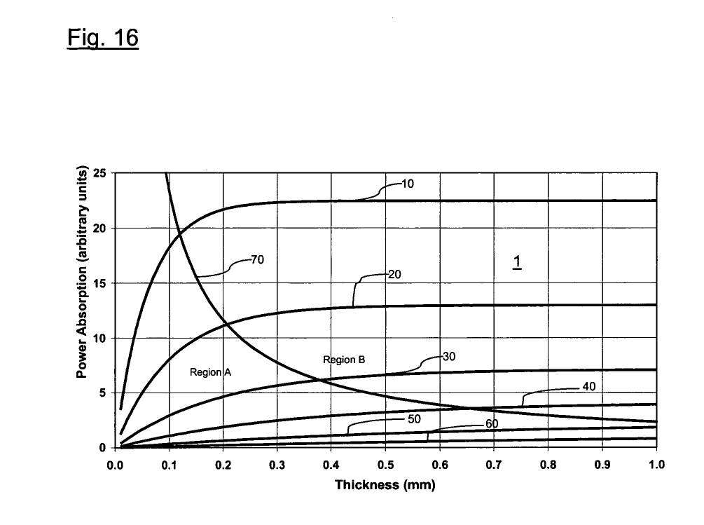

FIG. 16 shows a graph 1 indicating the power absorption for different Ti6Al4V rotor blade thicknesses at different sensor operating frequencies. Line 10 shows data obtained at 30.0 MHz, line 20 at 10.0 MHz, line 30 at 3.0 MHz, line 40 at 1.0 MHz, line 50 at 0.3 MHz and line 60 at 0.1 MHz. Line 70 shows the sensor operating boundary, i.e. the minimum thickness that a rotor blade made from Ti6Al4V may have for it to be adequately detected by the sensor. Graph 1 was modelled based on the equations described below.

Region A of graph 1 indicates how at low frequency, the power dissipation per unit area of target varies in proportion with the product of target thickness and frequency. For relatively thin targets and low operating frequencies this product is small, resulting in a poor signal. This frequency region is typically where eddy current sensors operate. Graph 1 shows the poor signals available for eddy current sensors detecting thin metallic targets.

Region B of graph 1 offers an improved signal. In region B the signal is substantially independent of target thickness and varies substantially as the square root of frequency. The present invention operates substantially under conditions shown in region B of graph 1.

Equation 3 describes how the skin depth, δ, of the target (e.g. rotor blade) varies with the sensor electromagnetic field properties.

$$δ = \sqrt{\frac{2 ρ}{μ ω}} \qquad Equation 3$$

where ρ is the resistivity of the target, μ is its magnetic permeability and ω is the operating angular frequency of the sensor electromagnetic field.

Equation 4 describes how the H-field generated by the sensor electromagnetic field decays with depth into the target's material.

H=Hₒe^{x/δ} Equation 4

where Hₒ is the field at the surface of the target and x is zero at the surface of the material and increasingly negative with increasing depth into the target.

The high frequency power absorption per unit area, W, of the surface of the target is proportional to:

W∝Hₒ²\sqrt{μρω}(1−e^{-2l/δ}) Equation 5

For targets whose thickness is 1>>δ this approximates to:

W∝Hₒ²\sqrt{μρω} Equation 6

so that the dependence on target thickness is negligible or zero where 1>>δ.

For thin targets where 1<<δ Equation 5 leads to the approximate relation:

W∝Hₒ²μlω Equation 7

and so the dependence on target resistivity ρ, vanishes.

From Equations 3 and 4 it can be seen that with antenna electromagnetic fields at frequencies at or above that for which the thickness of the target is equal to the skin depth, the magnetic component of the sensor electromagnetic field is excluded from the interior (i.e. bulk) of the target and the target acts effectively as a diamagnet. This corresponds to region B in graph 1 of FIG. 16. The rotor blade sensor may be described as acting in loss output mode in region B of graph 1.

Note that the sensor operating boundary 70 indicates the limitations of this specific embodiment. However, other embodiments may alter the shape of this operating boundary such that thinner rotor blades may be satisfactorily detected.

From graph 1 it can be seen that the use of a higher frequency oscillator driver-detector circuitry (in the MHz range and above) has several advantages.

Typically, the frequency of the electrical oscillator may be several orders of magnitude higher than the mechanical rotational frequency of the rotor blade, thus the fidelity with which the mechanical movement may be sensed may be of very high quality. As an example, consider a 10 blade turbine running at 5 kHz interrogated by a single sensor disposed at some fixed point on its circumference. The sensor must register a blade pass event every 20 microseconds. The response time of the sensor is approximately equal to its Q multiplied by the period of the electrical carrier frequency. A sensor running at 10 MHz with a Q of order 100 is therefore well able to respond to blade-pass events.

As will be appreciated by the skilled person, details of the above embodiment may be varied without departing from the scope of the present invention, as defined by the appended claims.

1. A rotor blade sensor for detecting a rotor blade comprising:
an electrical oscillator arranged to generate an oscillating signal;
an antenna including a coil having one or two winding layers coupled to the electrical oscillator, and having a plurality of electrical characteristics; wherein the antenna is driven in use by the oscillating signal of the oscillator at substantially a resonant frequency of the antenna, whereby the antenna generates an antenna electromagnetic field that interacts with a rotor blade such that the electrical characteristics of the antenna vary as the interaction between the antenna and the rotor blade changes; and
a detector circuit arranged to monitor the electrical characteristics of the antenna.

2. The rotor blade sensor of claim 1, wherein the resonant frequency is a lowest resonant frequency of the antenna.

3. The rotor blade sensor of claim 1, wherein the electrical characteristics of the antenna arranged to be monitored by the detector circuit include a resonant frequency of the antenna.

4. The rotor blade sensor of claim 3, wherein the detector circuit is arranged to monitor the resonant frequency of the antenna by monitoring a frequency of the oscillating signal driving the antenna.

5. The rotor blade sensor of claim 1, wherein the electrical characteristics of the antenna arranged to be monitored by the detector circuit includes a Q of the antenna.

6. The rotor blade sensor of claim 5, wherein the detector circuit is arranged to monitor the Q of the antenna by monitoring an amplitude of the oscillating signal driving the antenna.

7. The rotor blade sensor of claim 1, further comprising a shunt conductance arranged to control a Q of the antenna.

8. The rotor blade sensor of claim 7, wherein the shunt conductance comprises a coaxial cable arranged to couple the electrical oscillator to the coil.

9. The rotor blade sensor of claim 1, wherein the antenna further comprises a capacitor arranged in parallel with the coil.

10. The rotor blade sensor of claim 8, wherein the antenna further comprises a capacitor arranged in parallel with the coil, and wherein the capacitor is arranged across the coaxial cable proximal to the end of the coaxial cable towards the coil.

11. The rotor blade sensor of claim 1, wherein a number of turns of the coil is less than or equal to 20.

12. The rotor blade sensor of claim 1, wherein the detector circuit is a Robinson demodulator detector.

13. The rotor blade sensor of claim 1, wherein the antenna is arranged to interact with a rotor blade by moving the rotor blade relative to the antenna.

14. The rotor blade sensor of claim 1, wherein the detector circuit is further arranged to indicate velocity, angular velocity, blade separation, antenna-blade separation, vibration, eccentricity or material properties of the rotor blade by monitoring the electrical characteristics of the antenna.

15. The rotor blade sensor of claim 1, wherein the antenna is arranged to interact with a rotor blade by moving the rotor blade past the antenna.

16. The rotor blade sensor of claim 1, wherein the coil is formed from wire having a diameter greater than 0.25 mm.

17. The rotor blade sensor of claim 1, wherein the electrical oscillator and detector circuit are integral.

18. The rotor blade sensor of claim 1, wherein the frequency of the oscillating signal is high enough such that the skin depth of the rotor blade is equal to, less than or substantially less than the thickness of the rotor blade.

19. The rotor blade sensor of claim 1, suitable for detecting a non-ferrous rotor blade.

20. The rotor blade sensor claim 1, suitable for detecting a rotor blade manufactured from one or more materials selected from the group consisting of non-ferrous metallic elements, titanium, aluminium, nickel, vanadium, copper, iron, manganese, molybdenum, magnesium, non-ferrous alloys thereof, or ferrous alloys thereof.

21. The rotor blade sensor of claim 1, wherein the oscillating signal has a frequency above 1 MHz.

22. The rotor blade sensor of claim 1, wherein the oscillating signal has a frequency above 3 MHz.

23. The rotor blade sensor of claim 1, wherein the oscillating signal has a frequency above 10 MHz.

24. The rotor blade sensor of claim 1, wherein the oscillating signal has a frequency above 100 MHz.

25. The rotor blade sensor of claim 1, wherein the antenna further comprises a shroud formed from or including an electrically conductive material.

26. The rotor blade sensor of claim 1, wherein the antenna further comprises thin sheets formed from or including an electrically conducting material for shaping the antenna electromagnetic field.

27. The rotor blade sensor of claim 25, wherein the shroud has an electrically conductive coating whose thickness is greater than or equal to the skin depth in that coating at an operating frequency of the sensor.

28. The rotor blade sensor of claim 25, wherein the electrically conductive material is copper.

29. The rotor blade sensor of claim 1, wherein a frequency of the oscillating signal is high enough such that a magnetic component of the antenna electromagnetic field is substantially excluded from an interior of the rotor blade in use.

30. A rotor blade sensor for detecting a rotor blade comprising:
an electrical oscillator arranged to generate an oscillating signal;
an antenna including a coil comprising a plurality of winding layers, each layer being separated by a spacer for substantially reducing inter-layer capacitance, being coupled to the electrical oscillator, and having a plurality of electrical characteristics; wherein the antenna is driven in use by the oscillating signal at substantially a resonant frequency of the antenna, so that the antenna generates an antenna electromagnetic field that interacts with a rotor blade such that the electrical characteristics of the antenna vary as the interaction between the antenna and the rotor blade changes; and
a detector circuit arranged to monitor the electrical characteristics of the antenna.

31. The rotor blade sensor of claim 30, wherein the spacer or spacers are formed such that inter-layer capacitances are reduced to such an extent that in use currents flowing in each turn of the coil are substantially in phase.

32.-33. (canceled)

34. A rotodynamic machine comprising:
at least one rotor blade; and
a rotor blade sensor for detecting the rotor blade comprising:
an electrical oscillator arranged to generate an oscillating signal;
an antenna including a coil having one or two winding layers coupled to the electrical oscillator, and having a plurality of electrical characteristics; wherein the antenna is driven in use by the oscillating signal of the oscillator at substantially a resonant frequency of the antenna, whereby the antenna generates an antenna electromagnetic field that interacts with a rotor blade such that the electrical characteristics of the antenna vary as the interaction between the antenna and the rotor blade changes; and
a detector circuit arranged to monitor the electrical characteristics of the antenna.
